(19) United States
(12) Patent Application Publication
(10) Pub. No.: US 2010/0173124 A1
(43) Pub. Date: Jul. 8, 2010

(54) EXERCISE MAT AND METHOD FOR MANUFACTURING THE SAME

(76) Inventor: Kun-Chung LIU, Taichung Hsien (TW)

Correspondence Address: FROMMER LAWRENCE & HAUG LLP, 745 FIFTH AVENUE, NEW YORK, NY, 10151, US

(21) Appl. No.: 12/350,445

(22) Filed: Jan. 8, 2009

(51) Int. Cl. B32B 3/10; B32B 37/00

(52) U.S. Cl. 428/137; 156/285

(57) ABSTRACT

An exercise mat includes: a core layer including upper and lower opposite surfaces; and upper and lower layers being respectively heat-pressed on the upper and lower opposite surfaces of the core layer. The upper and lower layers are independently made of a foamed material, and have a plurality of holes that are formed therethrough and that extend to the respective one of the upper and lower opposite surfaces of the core layer. The core layer is an elastomer that is thermally compatible with the upper and lower layers, and that has a higher density than those of the foamed material of the upper and lower layers. A method for manufacturing an exercise mat is also disclosed.

### BACKGROUND OF THE INVENTION

1. Field of the Invention

This invention relates to an exercise mat and a method for manufacturing the same, more particular to an exercise mat for activities on the ground, such as yoga, pilates, etc.

2. Description of the Related Art

With the use of an exercise mat, an activity that takes places on the ground or on the floor, such as yoga, pilates, push-up, sit-up, etc., is made easier.

As disclosed in the seventh embodiment in Taiwan utility model no. M312342, since an exercise mat constituted by upper and lower layers made of foamed materials is soft, and since it can effectively prevent users from getting hurt during exercise, such an exercise mat is the most popular one nowadays.

Basically, a method for manufacturing such an exercise mat includes a step of heat-pressing an assembly of the upper and lower layers in a mold. When air or gas produced in the process resides in the exercise mat, the mat is likely to protrude upwardly on the surface thereof that results in user discomfort and that weakens bonding strength between the upper and lower layers.

Furthermore, the exercise mat constituted by the foam materials usually has a poor tensile strength, and is likely to deform or break. Thus, there is a need to further improve the quality of the exercise mat.

Another exercise mat having a net-like fabric layer disposed between the upper and lower layers to enhance the tensile strength of the whole mat is disclosed in Taiwan utility model no. M251621.

However, since the upper and lower layers (foam materials) are not thermally compatible with the fabric layer, and since there remains a problem concerning the air or gas residing in the exercise mat, the bonding force among the upper and lower layers and the fabric layer is weak. When doing an exercise on the mat, a shear stress is applied tangential to the upper layer that contacts the user. If the bonding force between the upper layer and the fabric layer is weak and the exercise being performed is intensive, the upper layer is likely to peel-off from the fabric layer.

### SUMMARY OF THE INVENTION

Therefore, in order to solve the problems mentioned above, an object of the present invention is to provide an exercise mat that can alleviate residual air or gas therein, and that has an improved tensile strength. Particularly, compared to the prior art, an upper layer of the exercise mat has a higher anti-peel-off strength.

According to one aspect of the present invention, there is provided an exercise mat comprising: a core layer including upper and lower opposite surfaces; and upper and lower layers being respectively heat-pressed on the upper and lower opposite surfaces of the core layer. The upper and lower layers are independently made of a foamed material, and have a plurality of holes that are formed therethrough and that extend to the respective one of the upper and lower opposite surfaces of the core layer. The core layer is an elastomer that is thermally compatible with the upper and lower layers, and that has a higher density than those of the foamed material of the upper and lower layers.

According to another aspect of the present invention, there is provided a method for manufacturing an exercise mat, comprising:

(A) forming each of upper and lower layers from foamed plates, the upper and lower layers having upper and lower opposite surfaces, respectively;

(B) forming a core layer with upper and lower opposite surfaces from an elastomer material which is thermally compatible with the upper and lower layers and which has a higher density than those of the upper and lower layers;

(C) after step (A), in each of the upper and lower layers, forming a plurality of holes therethrough that extend from the upper surface to the lower surface thereof; and

(D) after steps (B) and (C), after disposing the upper and lower layers respectively on the upper and lower surfaces of the core layer, heat-pressing an assembly of the upper and lower layers and the core layer in a mold.

Preferably, in step (D), the mold is vacuum pumped during heat-pressing.

Preferably, a fabric layer is disposed in the exercise mat to further improve the tensile strength of the whole mat.

The fabric layer may be disposed between the core layer and the upper layer, or between the core layer and the lower layer. Optionally, it is possible to dispose two fabric layers on the upper and lower opposite surfaces of the core layer, respectively.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded cross-sectional view illustrating the first embodiment of an exercise mat before heat-pressing according to the present invention;

FIG. 2 is a cross-sectional view illustrating the exercise mat of the first embodiment during heat-pressing;

FIG. 3 is a cross-sectional view illustrating a product of the first embodiment;

FIG. 4 is an exploded cross-sectional view illustrating the second embodiment of an exercise mat before heat-pressing according to the present invention;

FIG. 5 is a cross-sectional view illustrating the exercise mat of the second embodiment during heat-pressing; and

FIG. 6 is a cross-sectional view illustrating a product of the second embodiment.

### DETAILED DESCRIPTION OF THE PREFERRED EMBODIMENTS

A method for manufacturing an exercise mat of the first embodiment of this invention comprises steps of:

### (A) Forming Upper and Lower Layers

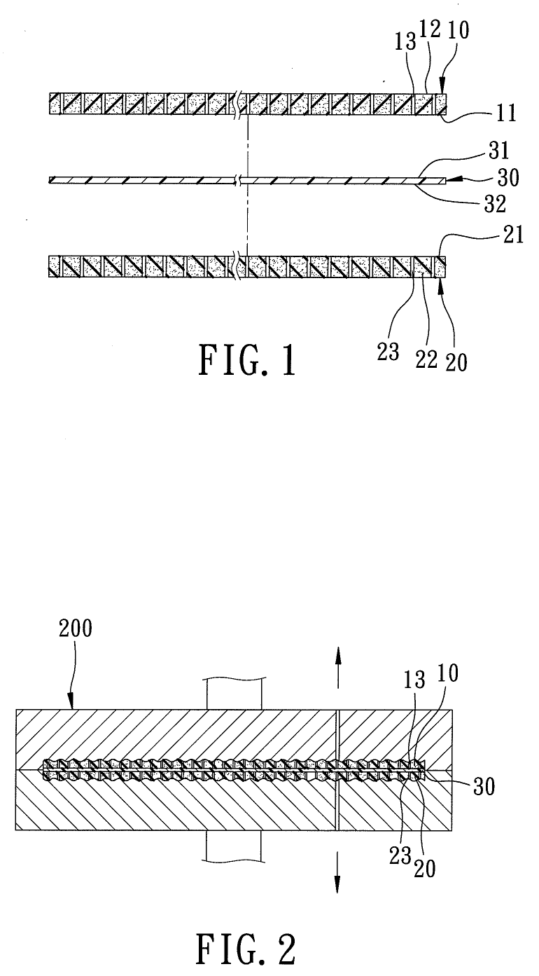

In step (A), each of upper and lower layers 10, 20 is formed from foamed plates, the upper and lower layers 10, 20 having upper and lower opposite surfaces (i.e., upper surfaces 12,21 and lower surfaces 11, 22), respectively (see FIG. 1).

The upper and lower layers 10, 20 are independently made of a foamed material, such as a foamed thermoplastic elastomer. The thermoplastic elastomer is selected from the group consisting of thermoplastic polyurethane elastomer, thermoplastic rubber, polyolefin series elastomer, methacrylate butadiene rubber, and styrene butadiene rubber.

Basically, the upper layer 10 is the layer that is for contact with users, and the lower layer 20 is the layer that is for contact with the ground or the floor. The materials of the upper and lower layers 10, 20 can be the same or different.

In this embodiment, each of the upper and lower layers 10, 20 formed during the step (A) is a plate with a thickness of about 2˜3 mm.

### (B) Forming a Core Layer

In step (B), a core layer 30 with upper and lower opposite surfaces 31, 32 is formed from an elastomer material which is thermally compatible with the upper and lower layers 10, 20 and which has a higher density than those of the upper and lower layers 10, 20 (see FIG. 1).

The elastomer material used for forming the core layer 30 is preferably a non-foamed material. For example, a non-foamed thermoplastic elastomer, such as thermoplastic polyurethane elastomer, thermoplastic rubber, polyolefin series elastomer, methacrylate butadiene rubber, and styrene butadiene rubber, can used to form the core layer 30.

In this embodiment, the core layer 30 formed during the step (B) is a non-foamed plate with a thickness of about 1˜2 mm.

### (C) Forming Holes

In step (C) that is conducted after step (A), in each of the upper and lower layers 10, 20, a plurality of holes 13, 23 are formed therethrough that extend from the upper surface 12,21 to the lower surface 11, 22 thereof.

In this embodiment, the step (C) is performed using a roller with a plurality of needles mounted thereon. When the upper or lower layer 10, 20 is conveyed through and contacted with the roller in a rotating state, a plurality of holes 13, 23 are formed by the roller pressing against the surface of the upper or lower layer 10, 20.

### (D) Heat-Pressing

In step (D) that is conducted after steps (B) and (C) the upper and lower layers 10, 20 respectively are disposed on the upper and lower opposite surfaces 31, 32 of the core layer 30, and heat-pressing an assembly of the upper and lower layers 10, 20 and the core layer 30 is conducted in a mold 200.

The heat-pressing is conducted at 90˜120° C. for 3˜5 seconds.

As long as the air or gas among the upper and lower layers 10, 20, and the core layer 30 can escape from the holes 13, 23 under the pressure from the step (D), the size of the holes 13, 23 should not be limited as long as the holes 13, 23 would not make users feel uncomfortable. In particular, the holes 13, 23 can be made smaller when vacuum sucking is also conducted in step (D).

In another embodiment, the step (D) can be conducted by conveying the assembly of the upper and lower layers 10, 20 and the core layer 30 through a pair of heated rollers.

As shown in FIG. 2, because the upper and lower layers 10, 20 are provided with the holes 13, 23, air or gas among the upper and lower layers 10, 20, and the core layer 30 can escape from the holes 13, 23 during the heat-pressing. Thus, in the present invention, residual air or gas in the exercise mat that can make users feel uncomfortable can be greatly alleviated, and the bonding force among the upper and lower layers 10, 20, and the core layer 30 is increased.

Preferably, a vacuum pump (not shown) is used with the mold 200 to force air or gas out of the assembly from the holes 13, 23. Thus, the bonding among the layers 10, 20, 30 and the comfort of the exercise mat 100 can be further ensured.

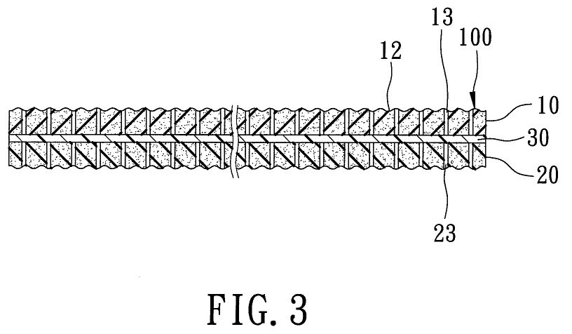

After step (D), a final product of the exercise mat 100 is shown in FIG. 3. If some defects (such as burrs or warps) are formed at edges of the exercise mat 100 during the aforesaid steps, it is possible to cut the edges off.

The exercise mat 100 in FIG. 3 comprises: a core layer 30 including upper and lower opposite surfaces 31, 32; and upper and lower layers 10, 20 being respectively heat-pressed on the upper and lower opposite surfaces 31, 32 of the core layer 30. The upper and lower layers 10, 20 have a plurality of holes 13, 23 that are formed therethrough and that extend to the respective one of the upper and lower opposite surfaces 31, 32 of the core layer 30. The core layer 30 is an elastomer that is thermally compatible with the upper and lower layers 10, 20 and that has a higher density than those of the foamed material of the upper and lower layers 10, 20.

Since the residual air or gas in the exercise mat 100 can be greatly alleviated, and since the core layer 30 is thermally compatible with the upper and lower layers 10, 20, the bonding force among the layers 10, 20, 30 can be enhanced, and particularly, compared to the prior art, an upper layer 10 of the exercise mat 100, 300 has a higher anti-peel-off strength. Besides, there is no protrusion on the surface of the exercise mat 100 caused by air or gas that can result in user discomfort.

Furthermore, since the core layer 30 has a higher density than those of the foamed material of the upper and lower layers 10, 20, the tensile strength of the exercise mat 100 is also much better than that of the prior art.

The surfaces of the upper and lower layers 10, 20 can be smooth surfaces or rough surfaces. Normally, the upper surface 12 of the exercise mat 100 is smooth, and the lower surface 22 thereof is rough. The upper surface 12 can be rough for massaging the user.

The thickness of the final product of the exercise mat 100 can be in various sizes, and is preferably controlled to be within 6˜8 mm.

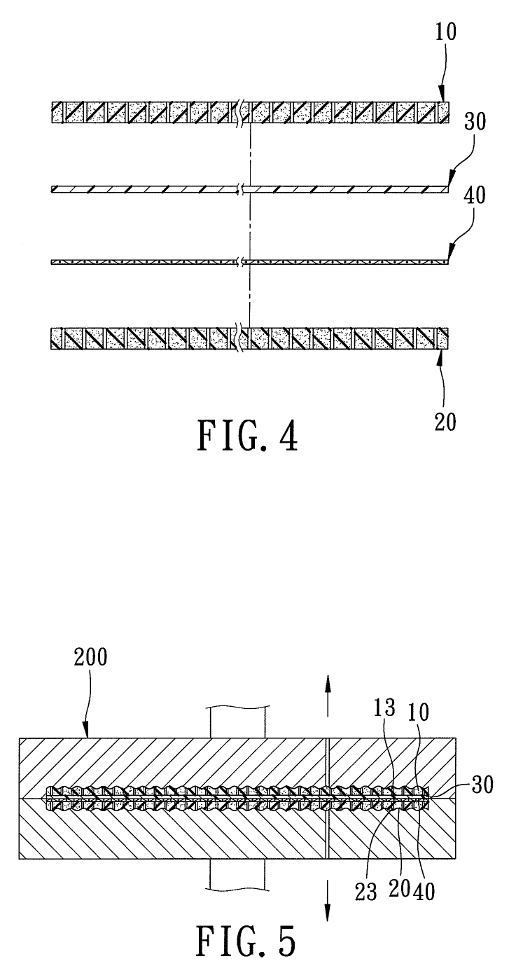

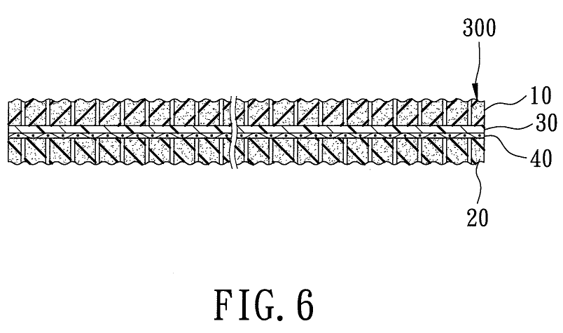

FIGS. 4˜6 illustrate the second embodiment of the exercise mat 300 of the present invention. The second embodiment differs from the previous embodiment in that a net-like fabric layer 40 is disposed between the core layer 30 and one of the upper and lower layers 10, 20 to further enhance the tensile strength of the exercise mat 300.

In the second embodiment, for an intense exercise, in order to prevent peeling of the upper layer 10 of the exercise mat 300 from the core layer 30, it is preferable that the fabric layer 40 is disposed between the core layer 30 and the lower layer 20. If necessary, the fabric layer 40 may be disposed between the core layer 30 and the upper layer 10. Optionally, it is also possible to dispose two fabric layers 40 on the upper and lower opposite surfaces 31, 32 of the core layer 30, respectively.

With the inclusion of the upper and lower layers 10, 20 and the aforesaid core layer 30 in the exercise mat 100, 300, the tensile strength of the exercise mat 100, 300 and the bonding force among the layers 10, 20, 30 are better than those of the prior art, and a more comfortable exercise mat 100, 300 can be obtained. Particularly, compared to the prior art, an upper layer 10 of the exercise mat 100, 300 has a higher anti-peel-off strength.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. An exercise mat, comprising:
a core layer including upper and lower opposite surfaces; and
upper and lower layers being respectively heat-pressed on said upper and lower opposite surfaces of said core layer;
wherein:
said upper and lower layers are independently made of a foamed material, and have a plurality of holes that are formed therethrough and that extend to the respective one of said upper and lower opposite surfaces of said core layer; and
said core layer is an elastomer that is thermally compatible with said upper and lower layers, and that has a higher density than those of said foamed material of said upper and lower layers.

2. The exercise mat of claim 1, wherein said upper and lower layers and said core layer are independently made of a material selected from the group consisting of thermoplastic polyurethane elastomer, thermoplastic rubber, polyolefin series elastomer, methacrylate butadiene rubber, and styrene butadiene rubber.

3. The exercise mat of claim 1, further comprising a fabric layer disposed between said core layer and one of said upper and lower layers.

4. The exercise mat of claim 1, further comprising a fabric layer disposed between said core layer and said lower layer.

5. A method for manufacturing an exercise mat, comprising:
(A) forming each of upper and lower layers from foamed plates, the upper and lower layers having upper and lower opposite surfaces, respectively;
(B) forming a core layer with upper and lower opposite surfaces from an elastomer material which is thermally compatible with the upper and lower layers and which has a higher density than those of the upper and lower layers;
(C) after step (A), in each of the upper and lower layers, forming a plurality of holes therethrough that extend from the upper surface to the lower surface thereof; and
(D) after steps (B) and (C), after disposing the upper and lower layers respectively on the upper and lower surfaces of the core layer, heat-pressing an assembly of the upper and lower layers and the core layer.

6. The method of claim 5, wherein instep (D), the assembly of the upper and lower layers and the core layer is disposed in a mold, and vacuum sucking is conducted concurrently during heat-pressing.

7. The method of claim 5, wherein the upper and lower layers and the core layer are independently made of a material selected from the group consisting of thermoplastic polyurethane elastomer, thermoplastic rubber, polyolefin series elastomer, methacrylate butadiene rubber, and styrene butadiene rubber.

8. The method of claim 5, wherein, in step (D), the assembly further includes a fabric layer disposed between the core layer and one of the upper and lower layers.
